(19) United States
(12) Patent Application Publication
(10) Pub. No.: US 2006/0014056 A1
(43) Pub. Date: Jan. 19, 2006

(54) Reformer and fuel cell system having the same

(76) Inventors: Zin Park, Suwon-Si (KR); Ju-Yong Kim, Suwon-Si (KR); Ji-Seong Han, Suwon-Si (KR); Hyun-Jeong Lim, Suwon-Si (KR); Eun-Suk Cho, Suwon-Si (KR); Ho-Jin Kweon, Suwon-Si (KR); Bok-Hwan Jung, Suwon-Si (KR)

Correspondence Address: CHRISTIE, PARKER & HALE, LLP, PO BOX 7068, PASADENA, CA, 91109-7068, US

(21) Appl. No.: 11/165,618

(22) Filed: Jun. 22, 2005

(30) Foreign Application Priority Data
Jun. 24, 2004 (KR) 10-2004-0047557

(51) Int. Cl. H01M 8/00; B01J 7/00

(52) U.S. Cl. 429/12; 48/61

(57) ABSTRACT

A fuel cell system comprises a reformer for generating hydrogen from fuel, at least one electricity generator for generating electric energy through an electrochemical reaction between hydrogen and oxygen, a fuel supply unit for supplying the fuel to the reformer and an oxygen supply unit for supplying oxygen to the electricity generator. The reformer includes a main body which has an inner space with a reformer inlet and a reformer outlet. A reaction section is disposed within the inner space of the main body. The reaction section includes a heat-generating element for generating thermal energy from externally applied energy such as electrical current. The heat-generating element has a corrugated structure with a catalyst layer formed on the surface. The corrugated structure defines a plurality of flow passages for the fuel and encourages both even flow distribution and turbulent flow.

### CROSS-REFERENCE TO RELATED APPLICATION

This application claims priority to and the benefit of Korean Patent Application No. 10-2004-0047557, filed on Jun. 24, 2004 in the Korean Intellectual Property Office, the entire content of which is incorporated herein by reference.

### FIELD OF THE INVENTION

The present invention relates to a fuel cell system and more particularly to a fuel cell system having an improved reformer.

### BACKGROUND OF THE INVENTION

In general, a fuel cell is a system for generating electric energy through an electrochemical reaction between oxygen and hydrogen contained in hydrocarbon materials such as methanol, ethanol, and natural gas.

Recently developed polymer electrolyte membrane fuel cells (hereinafter, referred to as PEMFCs) have been shown to exhibit excellent output characteristics, low operating temperatures, and fast starting and response characteristics. PEMFCs have a wide range of application including use as mobile power sources for vehicles, as distributed power sources for homes or buildings, and as small-sized power sources for electronic apparatuses.

A fuel cell system employing the PEMFC scheme basically requires a stack, a reformer, a fuel tank, and a fuel pump. The stack constitutes an electricity generation set having a plurality of unit cells. The fuel pump supplies fuel from the fuel tank to the reformer. The reformer reforms the fuel to generate hydrogen which is supplied to the stack.

The reformer generates hydrogen from the fuel containing hydrogen by a catalytic chemical reaction using thermal energy. Accordingly, the reformer may include a heat source for generating the thermal energy and a reforming reaction section for absorbing the thermal energy and generating hydrogen from the fuel.

In the reformer of a conventional fuel cell system, the heat source and the reforming reaction section are provided in separate vessels that are connected to one another through pipes. Each of the heat source and the reforming reaction section is generally formed as a single module with honeycombed passages parallel to the flow direction of fuel, where a catalyst layer for promoting a reaction is formed on the passages. Such modules can be manufactured by injection-molding a ceramic material and forming the catalyst layer on the surface of the passages. However, in a conventional reformer, since the passages through which the fuel passes are isolated from each other, the flow distribution of fuel is not uniform. In addition, since the diffusion rate of fuel in the catalyst layer is lowered, the whole reaction efficiency of the reformer is deteriorated. Furthermore, since the manufacturing process of the modules is complex, the manufacturing productivity is deteriorated.

### SUMMARY OF THE INVENTION

In accordance with the present invention a reformer which can enhance reaction efficiency and thermal efficiency with a simple structure is provided, as well as a fuel cell system having the reformer.

According to one aspect of the present invention, a reformer of a fuel cell system is provided. The reformer includes a main body defining an inner space, a reformer inlet and a reformer outlet. Within the inner space is a reaction section which forms a passage for fuel. The reaction section includes a heat-generating element for generating thermal energy from externally applied energy and a catalyst layer formed on the surface of the heat-generating element.

The reformer may further comprise an electrical power supply for supplying electric current to the heat-generating element. The heat-generating element may be made of metal having good conductivity.

The heat-generating element may have a pleated or corrugated shape.

A support layer may be formed between the heat-generating element and the catalyst layer to support the catalyst layer.

An insulating layer for electrically insulating the heat-generating element and the main body may be formed on inner surfaces of the main body.

According to another embodiment of the present invention, a fuel cell system is provided with a reformer for generating hydrogen from fuel, at least one electricity generator for generating electric energy through an electrochemical reaction of hydrogen and oxygen, a fuel supply unit for supplying the fuel to the reformer, and an oxygen supply unit for supplying oxygen to the electricity generator. The reformer is as was described above

The fuel supply unit and the reformer inlet of the main body may be connected through a first supply line and the reformer outlet of the main body and the electricity generator may be connected through a second supply line.

The fuel supply unit may include a fuel tank for storing a fuel containing hydrogen and a fuel pump connected to the fuel tank to transfer the fuel to the reformer.

The oxygen supply unit may include an air pump for supplying air to the electricity generator, and the air pump and the electricity generator may be connected through a third supply line.

A plurality of the electricity generators may be stacked to form a stack.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram schematically illustrating a fuel cell system according to an embodiment of the present invention;

FIG. 2 is an exploded perspective view illustrating a stack shown in FIG. 1;

FIG. 3 is a perspective view of a reformer of a fuel cell system according to an embodiment of the present invention; and

FIG. 4 is a cross-sectional view of the reformer shown in FIG. 3.

### DETAILED DESCRIPTION

Hereinafter, exemplary embodiments of the present invention will be described in detail with reference to the attached drawings such that the present invention can be put into practice by those skilled in the art. However, the present invention is not limited to the exemplary embodiments, but may be embodied in various forms.

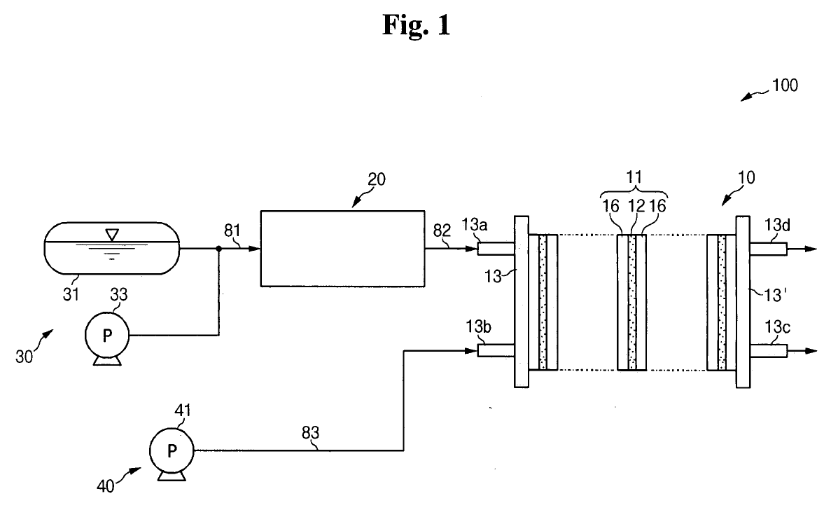

FIG. 1 is a block diagram schematically illustrating a fuel cell system according to an embodiment of the present invention.

Referring to FIG. 1, the fuel cell system 100 depicted is a polymer electrode membrane fuel cell (PEMFC) scheme, where fuel is reformed to generate hydrogen, and the hydrogen generated is electrochemically reacted with oxygen to generate electric energy.

The fuel used for the fuel cell system 100 may include liquid or gas fuel containing hydrogen such as methanol, ethanol, or natural gas. However, for ease of discussion, the fuel described below is a liquid fuel.

The fuel cell system 100 may utilize pure oxygen stored in an additional storage device as oxygen for reacting with hydrogen or may utilize air containing oxygen. The latter is exemplified in the following description.

The fuel cell system 100 basically comprises a stack 10 for generating electric energy through an electrochemical reaction between hydrogen and oxygen, a reformer 20 for generating hydrogen from the fuel, a fuel supply unit 30 for supplying the fuel to the reformer 20, and an oxygen supply unit 40 for supplying oxygen to the stack 10.

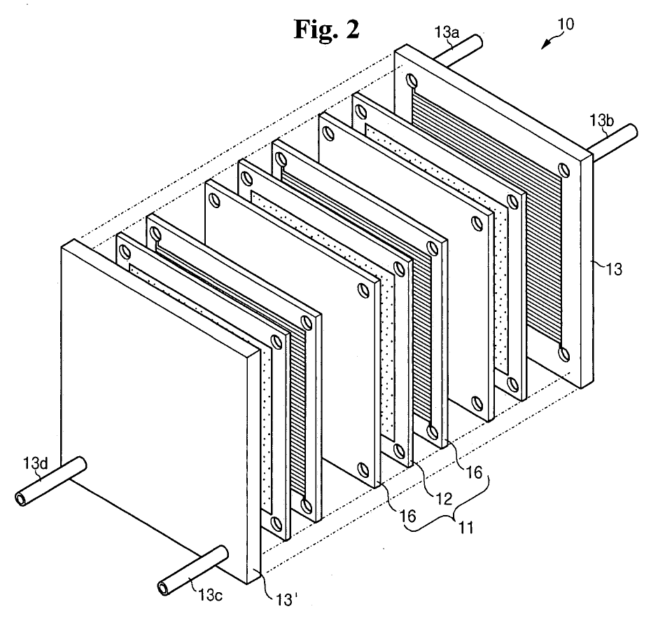

FIG. 2 is an exploded perspective view illustrating the stack shown in FIG. 1.

The stack 10 is composed of an electricity generator set which is formed by sequentially stacking a plurality of electricity generators 11.

Each electricity generator 11 includes separators 16 (also referred to as “bipolar plates” in the art) that are disposed in close contact with both surfaces of a membrane-electrode assembly (MEA) 12.

The MEA 12 has a predetermined active area where hydrogen and oxygen electrochemically react with each other and has a structure that an anode electrode is formed on one surface, a cathode electrode is formed on the other surface, and an electrolyte membrane is interposed between both electrodes.

The anode electrode converts hydrogen into electrons and hydrogen ions through the oxidation of hydrogen. The cathode electrode generates heat of a predetermined temperature and moisture through the reduction of the hydrogen ions and oxygen. The electrolyte membrane performs an ion exchange function of moving the hydrogen ions generated from the anode electrode to the cathode electrode.

The separators 16 function as conductors for connecting the anode electrodes and the cathode electrodes in series to each other, and also supply the MEAs 12 with hydrogen and oxygen.

Pressing plates 13 and 13′ are provided on the outermost ends of the stack 10 for bringing a plurality of electricity generators 11 in close contact with each other. However, other designs are available and the stack 10 may be constructed such that the pressing plates 13 and 13′ are excluded and the separators 16 positioned at the outermost sides of a plurality of electricity generators 11 can perform the function of the pressing plates 13 and 13′. The pressing plates 13 and 13′ may have the inherent function of a separator 16, in addition to the function of bringing a plurality of electricity generators 11 into close contact with each other.

A first inlet 13a for supplying hydrogen generated from the reformer 20 to the electricity generators 11 and a second inlet 13b for supplying air supplied from the oxygen supply unit 40 to the electricity generators 11 are formed in one pressing plate 13 of the pressing plates 13 and 13′. A first outlet 13c for discharging the remaining hydrogen not participating in the reaction of the electricity generators 11 and a second outlet 13d for discharging the non-reacted air containing moisture generated from the bonding reaction of hydrogen and oxygen in the electricity generators 11 are formed in the other pressing plate 13′.

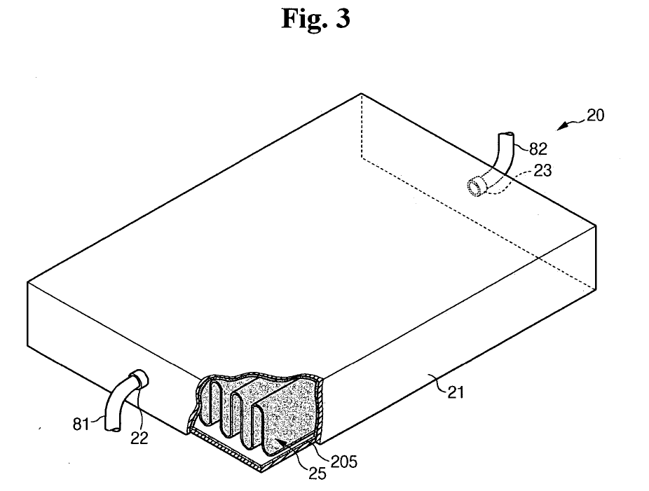

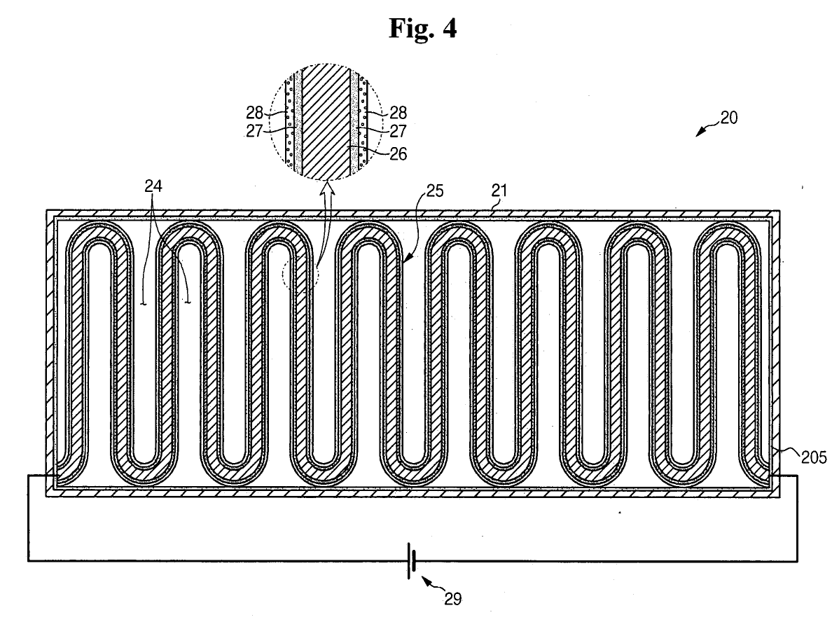

In the present invention, the reformer 20 generates hydrogen from the fuel containing hydrogen through a chemical catalytic reaction using thermal energy. The structure of the reformer 20 is described in more detail later with reference to FIGS. 3 and 4.

The fuel supply unit 30 for supplying the fuel to the reformer 20 includes a fuel tank 31 for storing the liquid fuel and a fuel pump 33 for pumping the fuel from the fuel tank 31. The reformer 20 and the fuel tank 31 are connected to each other through a tubular shaped first supply line 81. The reformer 20 and the first inlet 13a of the stack 10 are connected to each other through a tubular shaped second supply line 82.

The oxygen supply unit 40 includes an air pump 41 for feeding air with a predetermined pumping power to the stack 10. The air pump 41 and the second inlet 13b of the stack 10 are connected to each other through a third supply line 83.

Hereinafter, an example of the reformer 20 is described in detail with reference to the attached drawings.

FIG. 3 is a perspective view illustrating the reformer of a fuel cell system according to an embodiment of the present invention and FIG. 4 is a cross-sectional view of the reformer shown in FIG. 3.

Referring to the figures, the reformer 20 according to the present invention includes a main body 21, a reaction section 25 which is disposed inside the main body 21 and which generates hydrogen from the fuel containing hydrogen, and a power supply 29, shown schematically as supplying power to the reaction section 25 to generate thermal energy.

The main body 21 defines an inner space with a reformer inlet 22 through which fuel is supplied to the inner space and a reformer outlet 23 through which the hydrogen is discharged from the main body 21. According to this embodiment, the main body 21 comprises a rectangular parallelepiped housing structure with the reformer inlet 22 and the reformer outlet 23 at opposite ends. However, the main body 21 is not limited to the above-mentioned shape, but may be made in any one of a number of different shapes with a cylindrical shape being just one example.

The main body 21 can be made of a material having a heat-shielding property such as from ceramic, stainless steel, or aluminum.

The reformer inlet 22 of the main body 21 and the fuel tank 31 of the fuel supply unit 30 are connected to each other through the first supply line 81 described above. The reformer outlet 23 of the main body 21 and the electricity generators 11 of the stack 10 are connected to each other through the second supply line 82 described above.

The reaction section 25 generates hydrogen from the fuel through a catalytic reformation reaction using the thermal energy, and is disposed inside the main body 21 to form a plurality of passages 24 through which the fuel passes. The reaction section 25 includes a heat generating element 26 for generating the thermal energy from energy applied externally and a catalyst layer 28 which is formed on the surface of the heat-generating element 26 and which promotes the reforming reaction of the fuel.

A support layer 27 supporting the catalyst layer 28 may be formed between the heat-generating element 26 and the catalyst layer 28. The support layer 27 serves as a carrier supporting the catalyst layer 28 and may be made of a material such as alumina (Al₂O₃), silica (SiO₂), or titania (TiO₂).

The heat-generating element 26 may be formed by shaping a metal plate made of a metal such as stainless steel, aluminum, copper, nickel, iron, or the like in a pleated or corrugated arrangement. Accordingly, when viewed in cross section from a direction perpendicular to the longitudinal direction of the passages 24, the heat-generating element 26 has a wavelike shape.

By forming an insulating layer 205 on inner surfaces of the main body 21, the main body 21 and the heat-generating element 26 can be electrically insulated from each other even when both of them are made of conductive materials. However, in one embodiment, it is preferred that the heat-generating element 26 is spaced from the inner surface of the main body 21.

The power supply 29 is connected in series to both ends of the heat-generating element 26 and supplies electric current to the heat-generating element 26. The electrical resistance of the heat-generating element 26 generates the desired thermal energy.

In the present embodiment, although an electrical power supply 29 is exemplified as a source for supplying energy to the heat-generating element 26, various other sources may be used for supplying other types of energy to the heat-generating element 26.

In the reformer 20 according to the present embodiment, since the sectional shape of the heat-generating element 26 forming the passages 24 for fuel has a corrugated shape, the distribution of fuel through the passage 24 is uniform and the flow of fuel is turbulent, thereby enhancing the contact area of the fuel to the surface of the catalyst layer 28. In addition, since the structure of the reaction section in which the reforming reaction occurs is simple, it is simple to manufacture and productivity may be enhanced.

Operation of the fuel cell system according to the present invention will now be described in detail.

First, a predetermined amount of power is applied to the heat-generating element 26 from the power supply 29. Then, the heat-generating element 26 generates thermal energy due to its electrical resistance

The fuel pump 33 supplies the fuel stored in the fuel tank 31 to the inner space of the main body 21 through the first supply line 81 and the reformer inlet 22. The fuel flows through the passages 24 formed by the heat-generating element 26 where it absorbs thermal energy. Hydrogen is generated from the fuel through the reforming reaction of the fuel as it passes the catalyst layer 28.

Subsequently, hydrogen generated from the fuel is discharged through the reformer outlet 23 of the main body 21 and the hydrogen is supplied to the first inlet 13a of the stack 10 through the second supply line 82. At the same time, the air pump 41 supplies air to the second inlet 13b of the stack 10 through the third supply line 83.

In the stack 10, the hydrogen is supplied to the anode electrode of the membrane-electrode assembly 12 through the separators 16. Oxygen in the air is supplied to the cathode electrode of the membrane-electrode assembly 12 through the separators 16.

The anode electrode divides hydrogen into protons (hydrogen ions) and electrons by the oxidation reaction. The protons move to the cathode electrode through the electrolyte membrane and the electrons move to the cathode electrode of the neighboring membrane-electrode assembly 12 through the separators 16 or another terminal portion (not shown), but not through the electrolyte membrane. Current is generated by the flow of electrodes and heat and water are generated incidentally.

Although the exemplary embodiments of the present invention have been described, the present invention is not limited to the embodiments, but may be modified in various forms without departing from the scope of the appended claims, the detailed description, and the accompanying drawings of the present invention. Therefore, it is natural that such modifications belong to the scope of the present invention.

What is claimed is:

1. A reformer for a fuel cell system comprising:
a main body defining an inner space, a reformer inlet and a reformer outlet; and
a reaction section disposed in the inner space of the main body and defining a plurality of flow passages, the reaction section comprising a heat-generating element with a catalyst layer formed on a surface of the heat-generating element.

2. The reformer of claim 1 further comprising a power supply adapted to supply electric current to the heat-generating element.

3. The reformer of claim 2 wherein the heat-generating element is made of a conductive metal.

4. The reformer of claim 1 wherein the heat-generating element has a corrugated shape.

5. The reformer of claim 4 wherein the corrugated shape defines the plurality of flow passages, the flow passages running generally parallel to one another between the reformer inlet and the reformer outlet.

6. The reformer of claim 1 further comprising a catalyst support layer formed between the heat-generating element and the catalyst layer.

7. The reformer of claim 1 further comprising an insulating layer on an inner surface of the main body.

8. A fuel cell system comprising:
at least one electricity generator adapted to generate electric energy through an electrochemical reaction between hydrogen and oxygen;
a fuel supply unit;
an oxygen supply unit adapted to supply oxygen to the electricity generator,
a reformer for generating hydrogen from fuel supplied from the fuel supply unit, the reformer comprising: a main body defining an inner space, a reformer inlet and a reformer outlet; and a reaction section disposed in the inner space of the main body and defining a plurality of flow passages, the reaction section comprising a heat-generating element with a catalyst layer formed on a surface of the heat-generating element.

9. The fuel cell system of claim 8 wherein the fuel supply unit and the reformer inlet of the main body are connected through a first supply line and the reformer outlet of the main body and the electricity generator are connected through a second supply line.

10. The fuel cell system of claim 8 wherein the fuel supply unit comprises a fuel tank and a fuel pump.

11. The fuel cell system of claim 8 wherein the oxygen supply unit comprises an air pump and the air pump and the electricity generator are connected through a third supply line.

12. The fuel cell system of claim 8 further comprising a power supply adapted to supply electric current to the heat-generating element.

13. The fuel cell system of claim 8 wherein the heat-generating element is made of a conductive metal.

14. The fuel cell system of claim 8 wherein the heat-generating element has a corrugated shape.

15. The fuel cell system of claim 14 wherein the corrugated shape defines the plurality of flow passages, the flow passages running generally parallel to one another between the reformer inlet and the reformer outlet.

16. The fuel cell system of claim 8 further comprising a catalyst support layer formed between the heat-generating element and the catalyst layer.

17. The fuel cell system of claim 8 further comprising an insulating layer on an inner surface of the main body.

18. The fuel cell system of claim 8, wherein a plurality of electricity generators are arranged to form a stack.

19. A reformer for a fuel cell system comprising:
a main body defining an inner space;
a heat-generating element located within the inner space of the main body, the heat-generating element being of a corrugated shape and made of a conductive metal; and
a catalyst layer formed on a surface of the heat-generating element.

20. The reformer of claim 19 further comprising a power supply adapted to supply electric current to the heat-generating element.
